(19) United States
(12) Patent Application Publication
(10) Pub. No.: US 2010/0076810 A1
(43) Pub. Date: Mar. 25, 2010

(54) METHOD AND SYSTEM FOR AN ONLINE RESERVATION SYSTEM FOR SERVICES SELECTABLE FROM MULTIPLE CATEGORIES

(75) Inventor: KARIN M. LOEFFEN, Amsterdam (NL)

Correspondence Address: PERKINS COIE LLP, P.O. BOX 1208, SEATTLE, WA, 98111-1208, US

(73) Assignee: Libersy BV

(21) Appl. No.: 12/627,936

(22) Filed: Nov. 30, 2009

Related U.S. Application Data
(63) Continuation of application No. 12/106,311, filed on Apr. 20, 2008, now abandoned.
(60) Provisional application No. 60/915,482, filed on May 2, 2007.

(51) Int. Cl. G06Q 10/00; G06Q 30/00

(52) U.S. Cl. 705/9; 705/26

(57) ABSTRACT

The present invention teaches an online reservation system providing services of multiple categories of service providers. A user may enter the online reservation system by clicking on a button either embedded in a directory services search result for a particular service provider or located on a particular service provider's website. Alternatively, a user may search for service providers through the online reservation system by entering criteria such as category of service, pricing, rating, location, or time and day of availability of the service. Both users and service providers receive electronic confirmation and reminders for the booked appointments. Service providers may integrate all of their appointments with a calendar maintained by the online reservation system. The system automatically collects client data and may provide accounting services.

### CLAIM OF PRIORITY

This application is a continuation of co-pending U.S. patent application Ser. No. 12/106,311, filed Apr. 20, 2008, which in turn claims priority to U.S. Provisional Patent Application No. 60/915,482, filed May 2, 2007, both of which are hereby incorporated herein by reference.

### FIELD OF THE INVENTION

The present invention relates generally to an Internet-based reservation system for service appointments. More specifically, the present invention is a method and system for a reservation system capable of handling requests to book appointments for a service selected from multiple categories of services.

### BACKGROUND OF THE INVENTION

Advances in information technology and the Internet have driven tremendous shifts in marketing and business models. Many traditional brick-and-mortar stores have developed websites to attract consumer business through online sales of goods over the Internet. Today, online sales of consumer goods have matured to the point where consumers can routinely purchase thousands of items online over the Internet.

However, typically when a consumer is in need of a service, the consumer must speak directly with a service provider. Service providers are first identified by looking up providers either in a physical directory or through an online directory search service. When the consumer identifies a suitable service provider, the provider is usually contacted through the use of the telephone, and the consumer speaks directly with a staff member employed by the service provider to discuss pricing for services and dates and times when the service can be provided. Most service providers do not allow consumers to book appointments for their services online. Notable exceptions exist in the airline, hotel, and entertainment ticketing industries. With these particular service providers, consumers can book reservations online at the websites maintained by these large businesses.

### SUMMARY OF THE INVENTION

A variety of methods and systems are offered by the present invention for a user to access an online reservation system which offers the ability to book appointments for services with many different types of service providers.

According to one method, a user may use a web portal search engine provided by the reservation system to search for service providers. The user may limit the search based upon several possible criteria, such as keywords related to the service, a location or service area, a time and date for the service, pricing, the preferred location for the service to take place such as at the user's home, the office of the service provider, or if a telephone consultation is desired, or the distance that the user is willing to travel to the service provider or whether the service provider is willing to travel to meet the user. Once service providers are identified, the user can select a service provider and book an appointment online.

With another method, a clickable button is placed upon the service provider's website. A potential customer can click on the button to be transferred to the online services reservation website to book an appointment with that particular service provider.

According to yet another method, a clickable button is embedded in a directory services search result. Again, a potential customer can click on the button to be transferred to the online services reservation website to book an appointment with that particular service provider.

The online services reservation system offers many advantages to the consumer. Appointments for a variety of services may be made online at any time of day, even if the service provider's office is not open. The online reservation system is accessible through mobile electronic devices. Pricing of services can be compared through the system. An intuitive calendaring interface is available to assist the user in booking the appointment. Appointments may be easily canceled, re-scheduled, or rebooked online. Users may pay for the services online. Confirmations and reminders are sent to the user by email or text message.

Service providers also experience many advantages by participating in the online services reservation system. The service provider can focus on providing services rather than setting up and maintaining online appointment software. Appointments can be scheduled independently by online users at any time of day, not just business hours, thus potentially increasing business. The service provider receives confirmations and reminders about upcoming appointments. The appointment system can be connected to other software packages used by the service provider. Also, bookkeeping reports can be generated for the service provider.

### BRIEF DESCRIPTION OF THE DRAWINGS

FIG. 1 depicts a flow diagram illustrating an example process of booking an appointment using an online reservation system for services selectable from multiple categories of service providers, according to one embodiment.

FIG. 2 is a representative screen shot that may be displayed to a user accessing a web portal search engine for an online reservation system for services in accordance with the present invention.

FIGS. 3A-3E show a series of five representative screen shots that may be displayed to a user during the reservation process with an online reservation system for services in accordance with the present invention.

FIG. 4A depicts a flow diagram illustrating an example process of receiving information from a service provider to include in the online reservation system, according to one embodiment.

FIG. 4B depicts a flow diagram illustrating an example process of receiving bookings for a service provider, according to one embodiment.

FIG. 4C depicts a flow diagram illustrating an example process of providing access to a service provider information stored by the online reservation system, according to one embodiment.

FIGS. 5A-5C show a series of three representative screen shots that may be displayed to a service provider registering with the online reservation system for services in accordance with the present invention.

FIG. 6 depicts a block diagram of a plurality of client devices and a reservation system server coupled via a network, according to one embodiment.

FIG. 7 depicts a block diagram illustrating an example system for making reservations, the system to include a reservation system server coupled to a reservations database, and/or backup storage, according to one embodiment.

FIG. 8 depicts a block diagram illustrating an example of a reservations database that stores service provider information, services available, and consumer information, according to one embodiment.

### DETAILED DESCRIPTION OF THE INVENTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

The present invention teaches, among other things, booking an appointment with an online reservation system offering services from multiple categories of service providers. Through the use of an online reservation system incorporating multiple categories of services, consumers will have a simple and straightforward way to book everyday services including, but not limited to, tennis lessons, medical appointments, hairdresser appointments, educational courses, garages, electricians, banking appointments, and financial consultants. It will be apparent to those skilled in the art that these services were only chosen for illustration and that appointments for other types of services may be offered without departing from the spirit and scope of the present invention. With the online reservation system available for multiple types of services, a user will no longer need to call up each service provider individually to determine pricing and availability of services. The online reservation system for services allows users to obtain accurate and current information about the availability of desired services at any time of the day and from any location where the user can access the Internet.

From the perspective of a user attempting to find an everyday service provider for daily transactions, it would be beneficial for a simple method and system to be developed to enable a consumer to find a service provider and book appointments for all types of services online.

From the perspective of a service provider, it would be beneficial to be able to accept bookings 24 hours a day, receive text messages, email, and/or fax confirmations and/or reminders of bookings, market service availability online, and automatically collect client data.

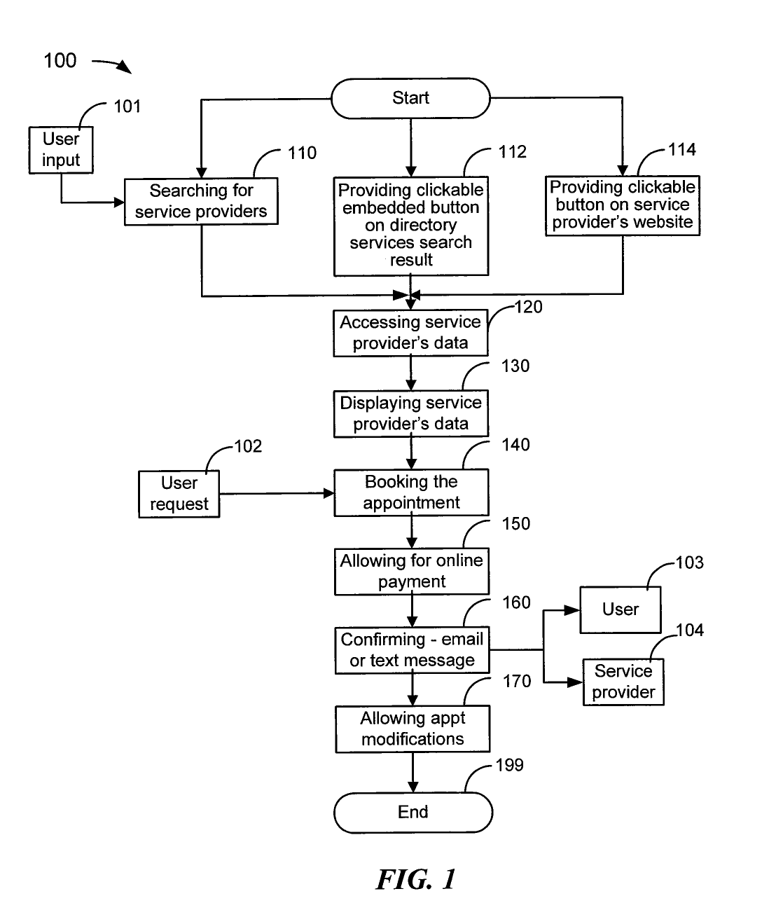

FIG. 1 is a flow chart 100 illustrating methods of booking an appointment with an online reservation system which offers services for multiple categories of service providers. There are three alternative methods for a user to book an appointment with the online reservation system. All three methods permit the user to access the online services reservation system through any device connected to the Internet including, but not limited to, computers and mobile electronic devices such as PDAs and smart phones.

In one method, a user inputs in block 101 desired service provider parameters to an online web portal. The portal provides a search engine for identifying service providers registered with the reservation system. Possible parameters that the user may specify include, but are not limited to, a category of service or a keyword relating to the type of service the user is seeking, location or service area where the user wishes to limit the search to, the time and day on which the user wishes to use the service, whether the user prefers to have the service performed at home, the office of the service provider, or through a video or telephone consultation, and how far the user is willing to travel or if the service provider must travel to the user. Examples of types of service providers include, but are not limited to, hairdressers, medical specialists, educational classes, garages, sports centers, entertainment venues, electricians, consultancies, masseurs, cleaning companies, banks, temping agencies, hospitals, local governments, and schools. The user may also specify limiting criteria for the particular service provider in block 101. For example, if the user were looking for a garage to provide an oil change for a Volkswagen car, the user might want to limit his search area to garages situated within a certain distance from his work or home and/or a garage that specializes in Volkswagens.

In block 110, the online reservation system takes the user input and searches in a database for service providers that meet the user's criteria. For example, the user can search for a specific time and day of availability, for a specific service provider, or for specific services. Appropriate service providers are identified. In block 120, the reservation system accesses data for those service providers that were identified in block 110. The data which is accessed includes but is not limited to dates and times that the service provider is available and pricing. Although the reservation system may be constantly updated, the latest availability and pricing is readily retrieved from the database.

Another method by which a user may access the online reservation system is through a directory services search. The directory services search may not be provided by the online reservation system, but search results corresponding to a service provider registered with the online reservation system will display an embedded clickable button. Thus, a user must first make a directory services search, and if the search result returns a service provider affiliated with the online reservation system, in block 112, the user may click upon the embedded button. Upon clicking this button, a user will be transferred to the online services reservation system. Then in block 120, requested data such as dates and times that the service provider is available and pricing will be accessed.

It will be apparent to one skilled in the art that the embedded clickable button that transfers a user to the online services reservation system may be placed upon any website and is not limited to the examples described above.

A further method by which a user may access the online reservation system is directly from the service provider's own website. In this case, a user has already identified the potential service provider so no search service is needed. In block 114, if the service provider is affiliated with the online services reservation system, the website will display a clickable button which, upon clicking by the user, will transfer the user to the online reservation system. Similar to the other two methods, in block 120, requested data such as dates and times that the service provider is available and pricing will be accessed.

The user is shown the retrieved data for the appropriate service providers in block 130. If the user reached block 130 by the first method through the use of a web portal provided by the online services reservation system, data corresponding to more than one service provider may be displayed. The user may choose to sort the service providers according to pricing or other criteria selectable by the user such as distance from a given location, earliest available appointment, etc. The availability of services as requested by the user in block 101 will be displayed. The availability of services is an aggregated availability which takes the availability of all resources needed for the service into account such as employees if the service can be rendered by several employees of a service provider, rooms, equipment, and products. Should the user's desired services not be available due to a scheduling conflict for any of the needed resources, a preferred embodiment of the present invention is to display availability of services through a calendaring interface. Alternatively, the user may be requested to select other service criteria such as another date and time or location or employee to check for availability of the service.

If the user reached block 130 by clicking on a button as in block 112 or block 114, availability of services through the service provider may be displayed through a calendaring interface, or the user may be requested to select specific service criteria such as date and time, location, and employee to check for availability.

In block 102, the user requests a particular service provider, a particular date and time that he wishes to reserve with the service provider, and any other relevant information for his selected service. Other relevant information include, but are not limited to, rooms, locations, events, and courses. This information is entered into the system by the user.

In block 140, the reservation system books the requested appointment with the service provider. The booking will block off the time in the service provider's calendar so that another appointment can not be booked by the service provider's office. Thus, the online services reservation system works in parallel with any bookings that the service provider wishes to make independently of the system. The service provider ultimately maintains control over his own calendar.

In one embodiment, the user is allowed to pay the service provider online, as indicated by block 150. Alternatively, the user may choose to pay the service provider at the time the service is provided. The service provider may specify whether a full or partial pre-payment is required in order to reserve the requested service.

In block 160, the reservation system provides a confirmation email or text message of the appointment to the user in block 103 and to the service provider in block 104, according to the preference specified by each. If the user does not respond to the confirmation within a specified period of time, the appointment time slot will be released for other users. In one embodiment, reminders may be sent to the user and the service provider of the upcoming appointment. Both the user and the service provider may specify how many reminders and how far in advance of the appointment the reminders should be sent.

Finally, the user may make modifications to the appointment in block 170. The modifications include, but are not limited to, canceling the appointment, rescheduling the appointment, or rebooking a favorite service provider. Any changes made by the user to the appointment is also sent by either email or text message to both the user and the service provider.

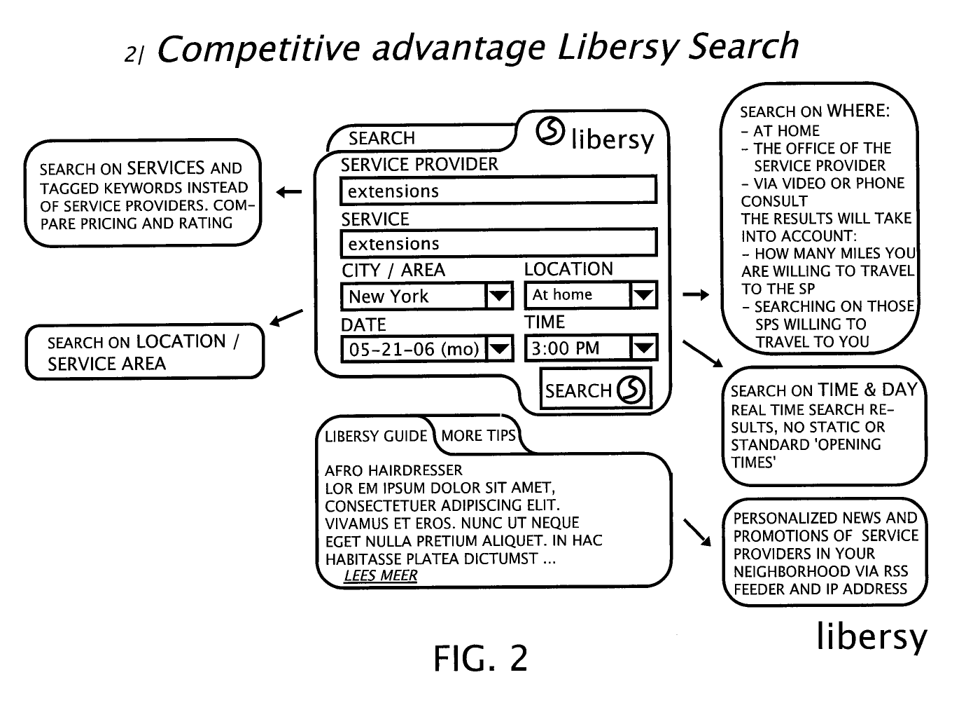

FIG. 2 is a representative screen shot that may be displayed to a user accessing a web portal search engine for service providers. The search engine provided by the reservation system incorporates flexibility into the search process. A user may search based upon the traditional service provider's name but may search based upon generic services of a specified type. Alternatively, the user may specify a preferred location or service area. Yet another parameter the user may use to control the search is the preferred time and day for the service. The user will have access to real-time search results. A user may also search based upon where the user would like the service to be provided, for example, at the user's home, at the office of the service provider, or through a video or telephone conference call. Additional search parameters include, but are not limited no, the distance the user is willing to travel to the service provider or the time it will take the user to travel to the service provider, and whether the service provider is willing to travel to the user's location.

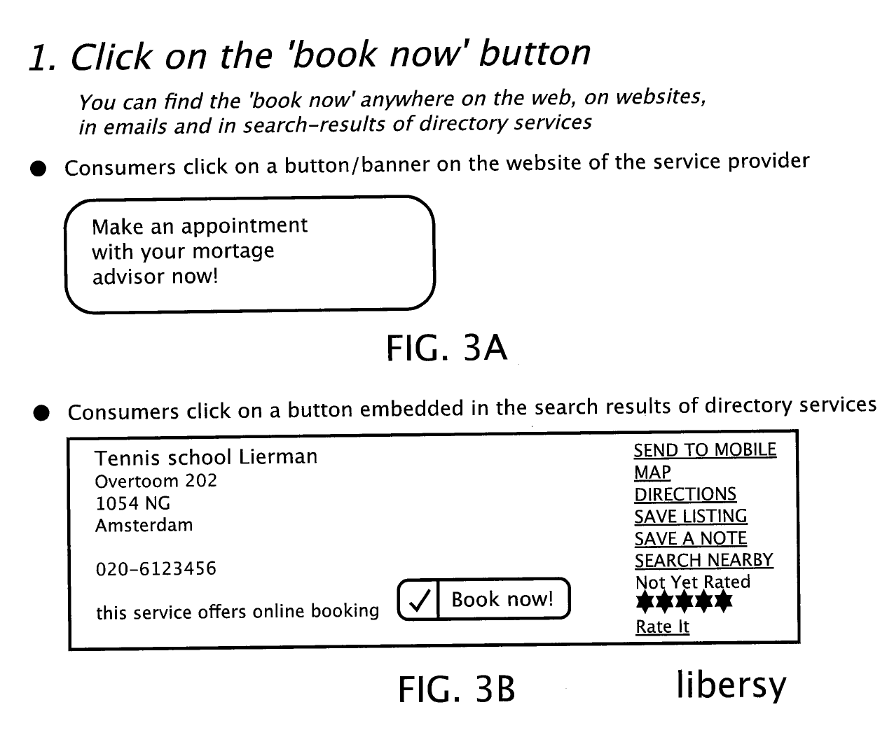

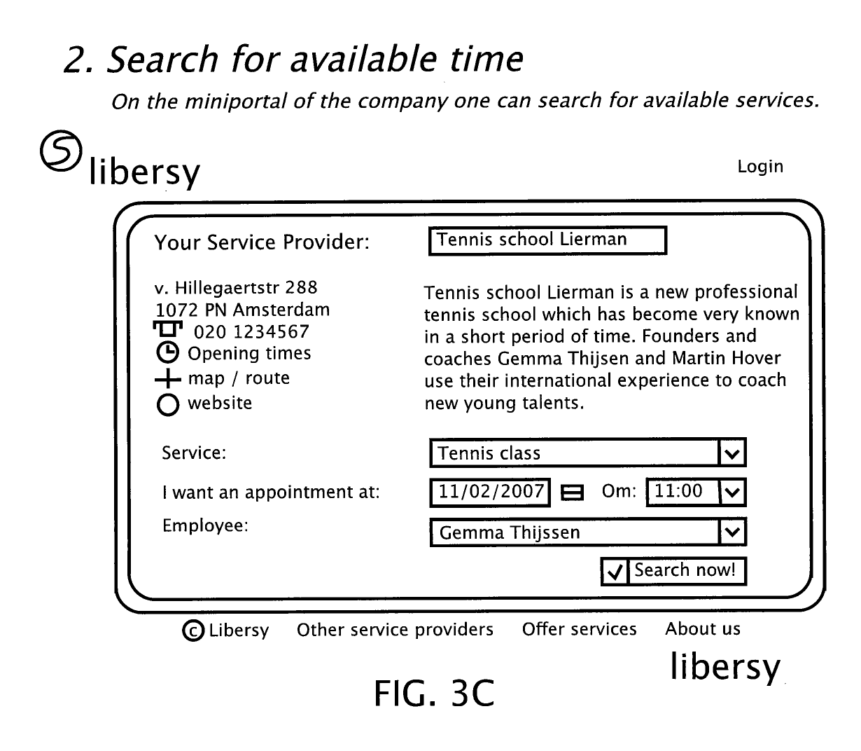

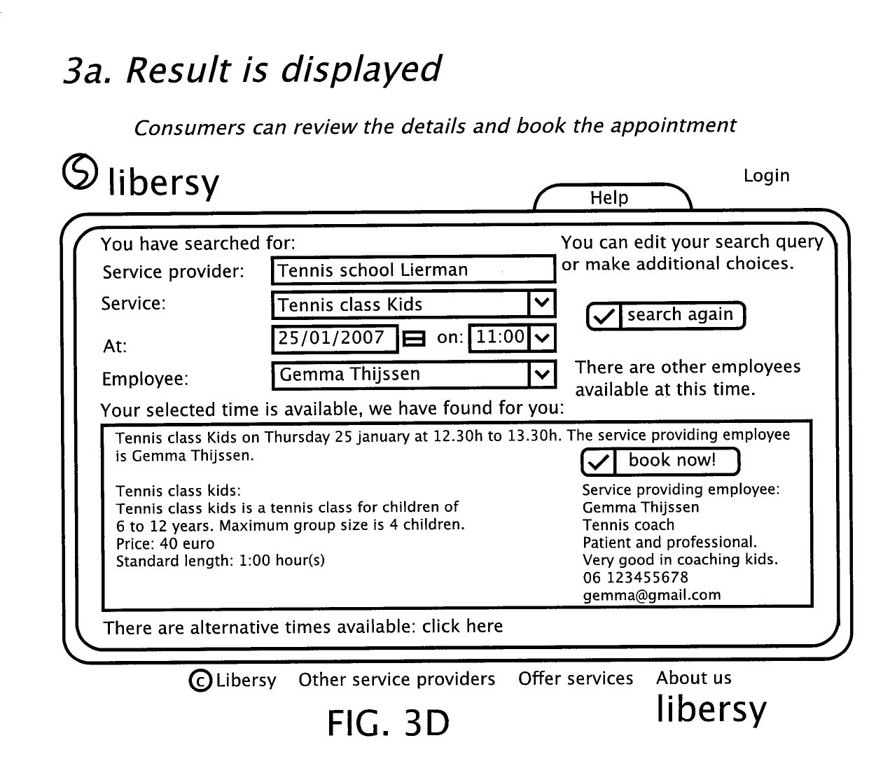

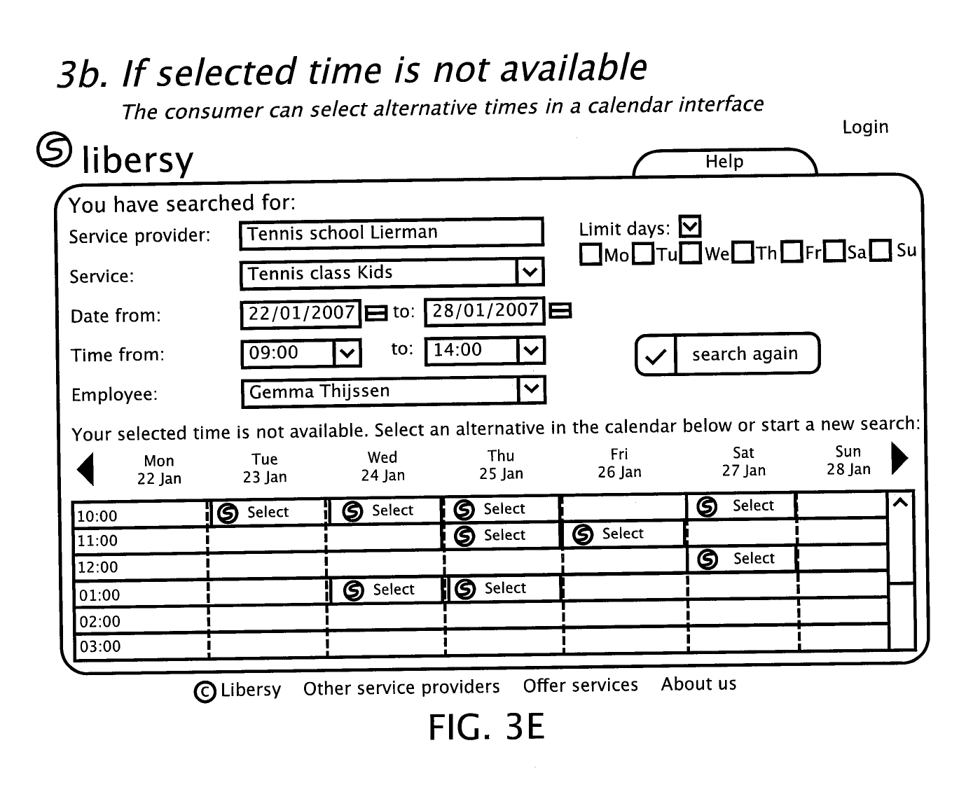

FIGS. 3A-3E show a series of representative screen shots that may be displayed to a user during the booking process. There are many ways in which a user may access the online services reservation system. Two of the ways involve the use of a simple clickable button which takes the user to a webpage to make a reservation with the online system. In FIG. 3A, the clickable button has been installed on the website of a service provider. A user will take this route to the reservation system when the user has independently located that particular service provider through a means other than the reservation system's search service. For example, the user may have heard of the service provider from a friend, or employed a different search engine for service providers, or may be a returning customer. By clicking upon the button on the service provider's website, the user is directed to a user-friendly interface to the online reservation system corresponding to block 120 in FIG. 1.

FIG. 3B shows the clickable button embedded in the search results obtained through directory services. Here, the user has made use of an online directory services search in order to identify a service provider as shown in this screen. The search result not only lists the traditional contact information for the service provider consisting of an address and telephone number, but a clickable button is displayed. If the user clicks on this button, the user is transferred to the online reservation system interface corresponding to block 120 in FIG. 1.

FIG. 3C shows the screen shot a user would see if the user employed the search engine provided by the online reservation system. This screen shot would correspond to block 101 in the flow chart of FIG. 1 where the user inputs requested parameters about a service provider.

One embodiment of the present invention is to place the clickable button on other portals that implement a search engine for services. Thus, the alternative portal would provide the search for services, and if the user clicks upon the displayed button, the user would be transferred to the online reservation system interface to complete a desired appointment with the selected service provider.

FIG. 3D shows an example of a search result conducted by the search engine provided by the online services reservation system. Here, the clickable button is located adjacent to the service provider that the online reservation system's search engine located. Clicking this button takes the user to a screen where the user must first register with the system before being allowed to book an appointment. After registration, the appointment is made and confirmed. FIG. 3E shows the use of a calendaring interface to facilitate the user's selection of an alternate time if the originally selected time is not available with the service provider.

The representative screen shots shown in FIG. 3 show the simplicity with which a user can find a service provider and make an online appointment.

The online reservation system for services will also help businesses to integrate their services online. It provides a platform which service providers can integrate into their own websites or which can be part of a directory search service or other local business sites. Service providers will not need to install and maintain their own software, rather an internet enabled computer with a standard web browser will be sufficient for a service provider to participate in the online reservation system for services.

The online system can also help streamline the service provider's business. Client data including address, email, telephone number, and credit card number can be collected automatically, and appointment data can be stored online at an external site which is backed up regularly. The booking system can be connected to other digital applications used by the service provider such as Microsoft Outlook, an existing company database, accounting software, or calendaring and planning software. Users may pay for services online at the time of booking to minimize the administrative burden of billing clients. Also, bookkeeping reports can be generated and sent to the service provider.

Users also have the option to cancel, reschedule, or book recurring appointments online without taking up the service provider's time. Confirmations, reminders, and cancellations are sent automatically to the service provider either by email or text messaging.

Any type of service provider may register to offer services and related products through the online reservation system. Typical categories of service providers include, but are not limited to, micro-sized businesses that have fewer than 10 employees, small-sized businesses that have fewer than 100 employees, medium-sized businesses that have fewer than 500 employees, large-sized businesses that have greater than 500 employees, government entities that are run by a government such as public schools, non-profit entities such as hospitals, associations such as a chamber of commerce, trade associations, and voluntary associations, and clubs such as athletic clubs, service clubs, school clubs, professional societies, social clubs.

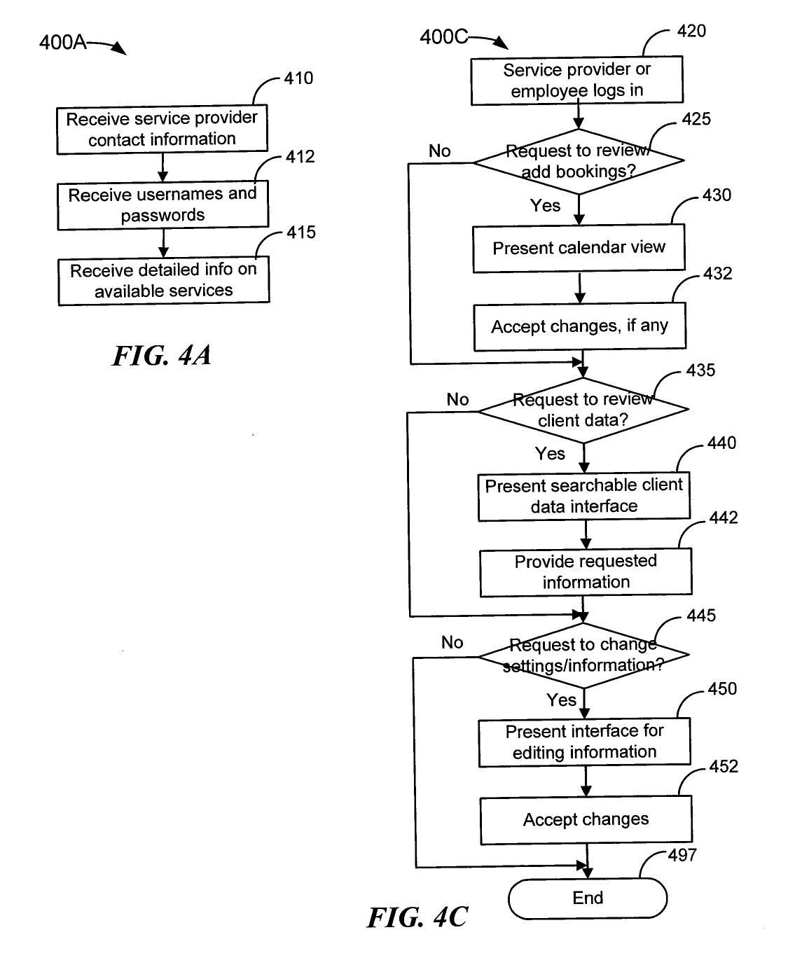

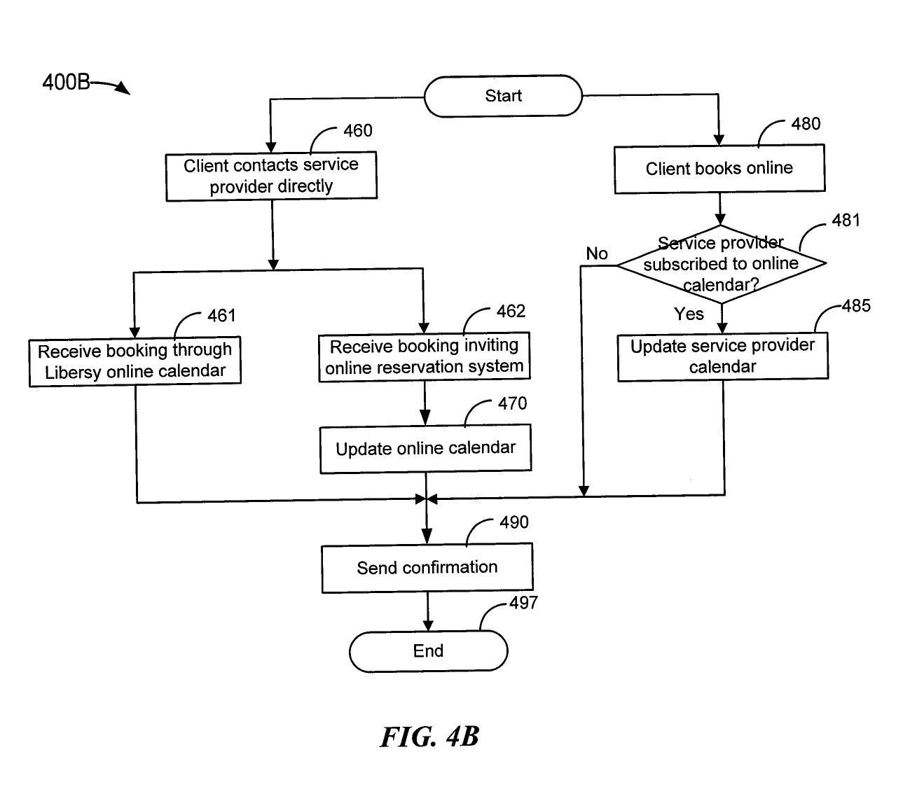

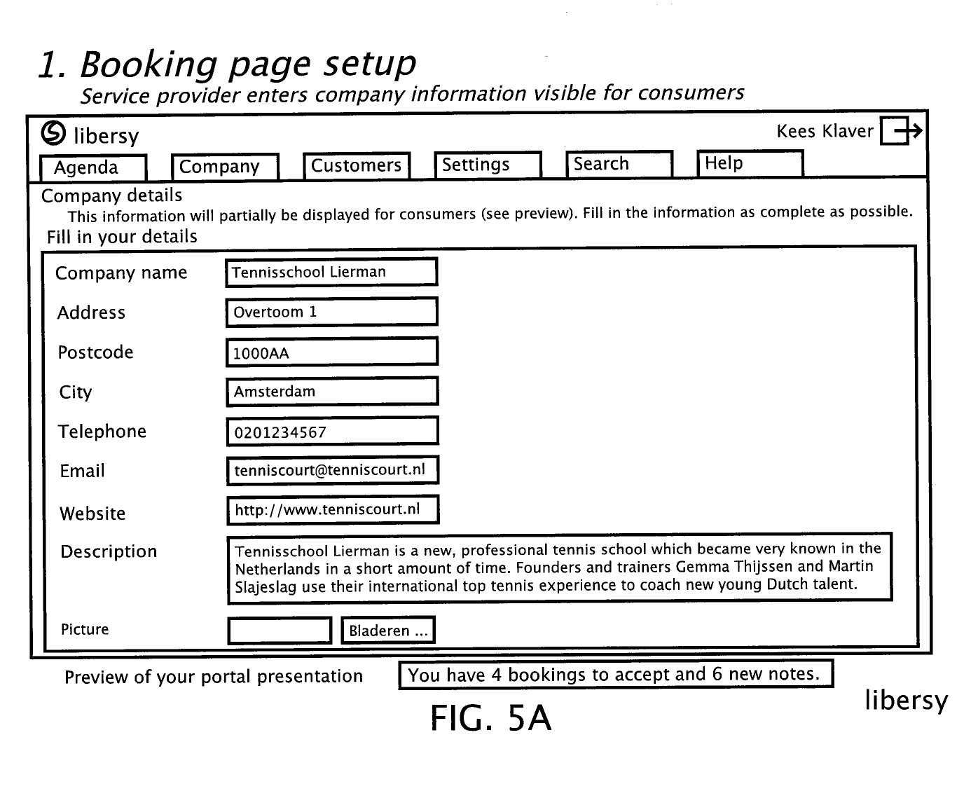

FIG. 4A depicts a flow diagram 400A illustrating an example process of obtaining information from a service provider to include in the reservations system, according to one embodiment.

At block 410, general information provided by the service provider during registration is received by the system. The service provider may be prompted by a registration form to fill in required information. A section may also be provided for optional information that the service provider would like to include. General service provider information may include, but is not limited to, the service provider's name, address, telephone number, email address, website, description of the service provider, and pictures.

At block 412, the system will prompt the service provider to select one or more usernames and passwords for each staff member that will be allowed to access the online calendar. Access to information for that service provider will be limited to those with passwords. In addition, the level of access may be restricted. For example, staff members who provide services may be able to access their own appointment calendars but not those of other staff members, or only supervisors may access billing information.

At block 415, detailed information about available services provided by the service provider and/or the service provider's staff members is received by the system. Detailed services information may include, but are not limited to, types of particular services, pricing, hours of availability, whether the service is available to the public or is limited to certain groups, type of services such as a normal service, a group event, or a course offering, maximum number of participants, location of the offered service, and the standard length of time for an appointment.

Staff members may input their own work schedules, such as the dates and times of their availability. For example, a tennis instructor may work for a particular tennis club only on the weekends but work on his own time for his own clients or at another tennis club during the week. In this case, the tennis instructor may enter availability with the first tennis club from 8 a.m. until 6 p.m. on Saturday and Sunday and no availability Monday through Friday. However, if the tennis instructor agrees to be available to work for the first tennis club seven days a week during the summer months of June and July, the tennis instructor may enter different availability times for those months. The tennis instructor's supervisor at the first tennis club may also have access to the change the tennis instructor's schedule in the system.

The online reservation system further permits a service provider to create and offer services in a flexible manner. Parameters the service provider may specify include, but are not limited to, determining the name of a service, the length of an appointment, the first and last time slots a particular service may be booked during any given day, the pricing structure, and the resources required to provide a given service. For example, if a service provider provides tennis instruction, the resources required to book a tennis lesson are a tennis instructor and a tennis court. The service provider may have five tennis instructors and ten tennis courts. If a client wishes to book a two-hour tennis lesson with a particular tennis instructor, John, the required resources are John's time and one of the ten tennis courts. The calendar view would show available time slots that are at least two hours long where both John is available and a tennis court is available. The calendar view thus takes into account all resources needed to provide a service, and the availability of a service is shown rather than merely the resources needed to provide a service. Thus, a service provider's receptionist does not need to remember to book any particular resource; the calendar view provides all times that satisfies the client's criteria.

In another example, specific services may be assigned a specific resource label. For example, suppose Amy, Betty, and Cathy are trained to provide massages, but Don and Elaine are not, however all five employees are beauticians. Then Amy, Betty, and Cathy would be labeled beauticians and masseurs, while Don and Elaine would be labeled just beauticians. Consequently, a facial treatment service would require a beautician as a resource, and a massage would require a masseur as a resource. When booking an appointment, the system takes into account the schedules of the appropriate resources. A specific room and employee may also be required for a service. A list of available resources and labels will be presented in a list to the service provider to select from when setting up an appointment for a service.

Pricing schedules may also be entered into the system. For example, a tennis court may be more expensive to rent during evening hours than during afternoon hours, and weekend hours may have different pricing from weekday hours. When the pricing information is entered into the system, the system may dynamically select the correct price according to the entered criteria when booking an appointment. Alternatively, if a client requests pricing within a certain range, the system may return available times that meet a client's price requirements.

Services may also be booked in specific increments, and pricing may change depending upon how long a service is needed. For example, a consultant's time may be booked by the hour at $50 per hour up to four hours, and the charge may decrease to $40 per hour for each hour after the first four hours.

After the information from block 410 and block 415 are received by the system, the service provider can start receiving bookings made through the internet. Alternatively, the service provider can add new bookings directly into the system calendar when a user approaches the service provider directly for an appointment, whether in person or over the telephone.

Use of the booking system by the service provider provides one integrated booking calendar. Moreover, the system simplifies locating client data, billing data, and tracking resources. In addition, the information provided in the above process may be used by the system to provide marketing services if the service provider wishes to make use of them.

FIG. 4B depicts a flow diagram 400B illustrating an example process of receiving bookings for a service provider at the online reservation system, according to one embodiment.

At block 460, a client may contact a service provider directly. For example, the client may visit a service provider site or the client may call the service provider on the telephone. In both situations, the client receives information from a receptionist or other service provider employee about the types of services offered, pricing, and availability. If desired, the client may book an appointment directly with the service provider, and the service provider has the booking information. The service provider may choose to enter the information into the online reservation system as described below.

First, at block 461, the online calendar receives the booking information when the service provider books the appointment directly in the reservation system's online calendar. To book the appointment in the online calendar, the service provider connects to the calendar application of the system through the internet, from a computer, a mobile phone, or any other method. Access to the service provider's calendar is restricted to people who have been provided with a username and password.

Once the information has been entered, at block 490, the service provider and client receive an appointment confirmation either by email, fax, or text message. The process ends at block 497.

Alternatively, at block 462, the service provider may book the appointment in a Microsoft Outlook calendar or other calendar application and invite the online reservation system in order to block the time from being booked by the online reservation system for another client. At block 470, the calendar maintained by the online reservation system for that service provider is updated. At block 490, the service provider and client receive an appointment confirmation either by email, fax, or text message. The process ends at block 497.

A client may also book an appointment online at block 480 without contacting the service provider directly, using one of the methods described in conjunction with flow chart 100. At decision block 481, the system determines whether the service provider subscribed to the online calendar. If the service provider has subscribed (block 481—Yes), at block 485, the appointment, including location, resources required, and customer information shows up in the service provider's Microsoft Outlook calendar. Alternatively, the system can export the appointment information to any other preferred type of electronic calendar connected to the Internet including, but not limited to, Google calendar and any iCal format.

Service providers may subscribe to the online reservation calendar to receive information for the entire service provider business, a specific service offered by the service provider, a specific employee, and/or any scheduled resource.

At block 490, the service provider and/or the employee who will be providing the service and the client receive an appointment confirmation either by email, fax, or text message. In one embodiment, an email appointment confirmation includes two response options, an ‘accept’ button and a ‘decline’ button. If the client clicks on the ‘accept’ button, the appointment information is exported to the client's calendar, and if the client clicks on the ‘decline’ button, the appointment resources are released.

In one embodiment, a service provider subscribes to the online reservation calendar when Microsoft Outlook is their primary calendar, and the service provider prefers not to click the ‘accept’ button for every email appointment confirmation.

In one embodiment, business owners who want to know about booked appointments may subscribe to the online reservation calendar because business owners are not personally booked by the calendar when a client books an appointment.

The process in flow diagram 400B ends at block 497.

If the service provider has not subscribed (block 481—No), at block 490, the service provider and client receive an appointment confirmation either by email, fax, or text message, and the process ends at block 497.

FIG. 4C depicts a flow diagram 400C illustrating an example process of accessing information stored by the online reservation system for the service provider, according to one embodiment.

At block 420, a service provider or a staff member of the service provider logs into the secured online reservation system. In order to protect the data, the person logging in must be pre-authorized and use a pre-registered username and password or other form of authentication.

At decision block 425, the system may prompt the service provider with a question to determine whether the service provider has logged in to review or add new bookings. If the service provider wishes to review or add new bookings (block 425—Yes), at block 430, the system presents a calendar view of the service provider's appointments. In one embodiment, the calendar may indicate, but is not limited to, the client who booked each appointment, the location of the appointments, the particular staff member providing the service, the length of the appointment, and whether the client has paid for the appointment. The calendar view may be searched by staff member, a particular date and/or time or a span of days or times, and client name. It will be apparent to a person skilled in the art that other criteria may also be used to search within the calendar view.

Once the appropriate calendar view is shown to the service provider, the service provider may take actions such as adding new bookings and changing bookings. At block 432, any additions or changes are accepted by the system.

If the service provider does not wish to review or add new bookings (block 425—No), the process continues to decision block 435 where the system may prompt the service provider with a question to determine whether the service provider wishes to review client data. If the service provider wishes to review client data (block 435—Yes), at block 440, a searchable client data interface is presented. Criteria for searching include, but are not limited to, name of client, date of service, whether payment has been received, and a bookkeeping summary over a specified time period.

At block 442, the system provides the requested information to the service provider. The information may be provided on a screen and/or emailed to the service provider.

If the service provider does not wish to review client data (block 435—No), the process continues to decision block 445. At decision block 445, the system may prompt the service provider with a question to determine whether the service provider wishes to edit settings or information about available services. If the service provider wishes to edit information, at block 450 the service provider is presented with an interface for editing available services or service provider information. Information that may be edited include, but is not limited to, changes in dates or times that services are available, rooms, staff members, or product availability, change of address or phone number, and adding new services, rooms, staff members or products. At block 452, the system accepts the edits made by the service provider, and the process ends at block 499.

If the service provider does not wish to review client data (block 445—No), the process ends at block 499.

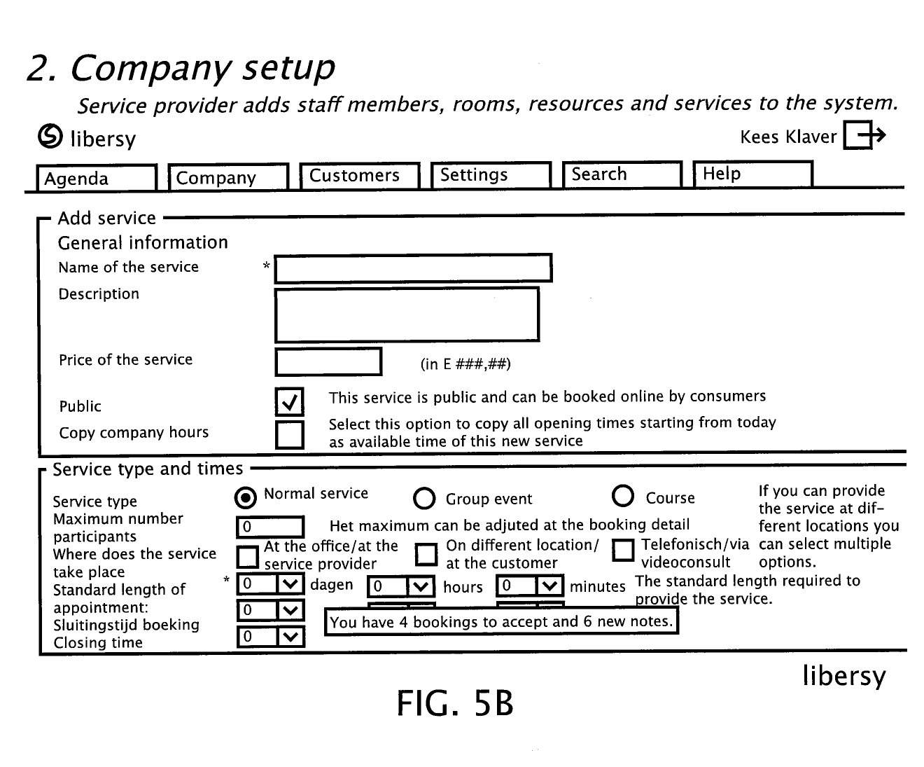

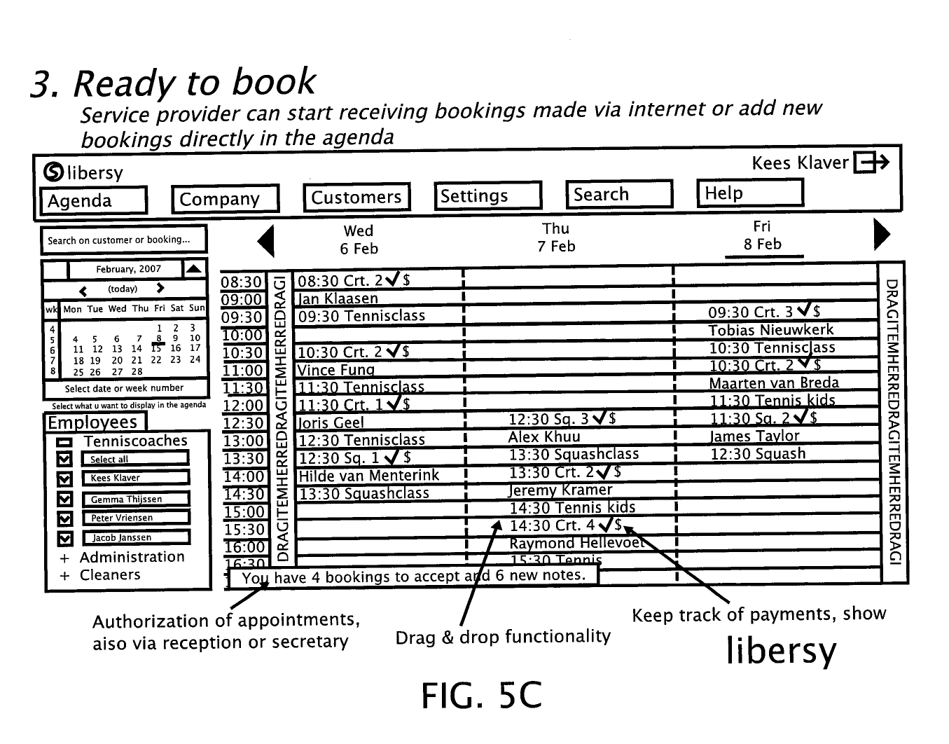

FIGS. 5A-5C show a series of three representative screen shots that may be displayed to a service provider during the process of registering to participate in the online reservation system.

FIG. 5A shows a form requesting basic identifying details about the service provider, such as contact information and a description of services that are offered.

FIG. 5B shows a screen shot in which a service provider is requested to enter information about the types of service offered, staff members supplying the services, rooms available, the location of the service, and any other available resources the service provider offers. Because service providers offering different types of services will be employing the online services reservation system, service providers must have the ability to specify different services offered through the system. For example, a service provider may want to list the type of service offered such as a music lesson or car mechanic's services; the type of rooms, such as with rental of space like a ballroom for a special event; products available such as chairs or tables for a hall rental for a banquet; courses available if the service offers instructional services such as different levels of swim classes; and events offered such as if a multi-track conference is being offered. It will be apparent to a person skilled in the art many that other types of services may be offered through the online services reservation system. The system is flexible and will support the offering of products provided by any type of service provider. Service providers will have the ability to specify the availability of the service and any associated products beings offered.

FIG. 5C shows a calendar which is accessible directly by the service provider and which the online reservation system also accesses to enter online bookings. The online reservation system for services may eliminate the need for service providers to hire a staff member to answer the telephone to schedule appointments with clients. Consequently, a service provider can focus his time and energy upon providing the best service possible without being concerned about the technical details associated with booking appointments online for the services offered. Moreover, the online services reservation system is available online at all times, even times when the service provider's office may not be open. Thus, business can be generated during all hours of the day at the convenience of the client, potentially attracting more business for the service provider. However, a service provider's participation in the online services reservation system does not preclude the service provider from personally accepting appointments with customers. These are the many ways in which a service provider would be benefited by registering and being affiliated with the online services reservation system.

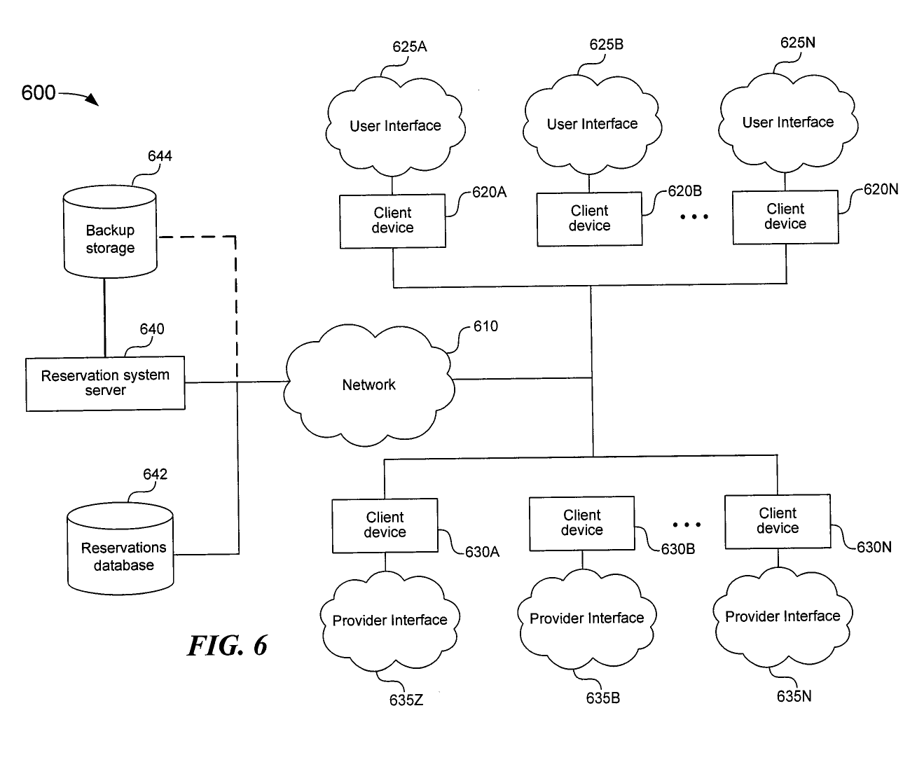

FIG. 6 illustrates a block diagram 600 of a plurality of client devices 620A-N, 630A-N, with user interfaces 625A-N or provider interfaces 635A-N, and a reservation system server 640 coupled via a network 610, according to one embodiment. More than one reservation system server 640 may be coupled to the network 610. Only one server is shown in FIG. 6 for clarity.

The plurality of client devices 620A-N, 630A-N may be any system and/or device, and/or any combination of devices/systems that is able to establish a connection with another device, a server and/or other systems. The client devices 620A-N, 630A-N typically include display or other output functionalities to present data exchanged between the devices to a user. For example, the client devices and content providers can be, but are not limited to, a server desktop, a desktop computer, a computer cluster, a mobile computing device such as a notebook, a laptop computer, a handheld computer, a mobile phone, a smart phone, a PDA, a BlackBerry™ device, a Treo™, and/or an iPhone, etc. In one embodiment, the client devices 620A-N, 630A-N are coupled to a network 610. In some embodiments, the client devices may be directly connected to one another.

In the example block diagram 600, client devices 620A-N may be accessed by users looking for a service provider, while client devices 630A-N may be accessed by service providers registered with the online reservation system. Client devices 620A-N have user interfaces 625A-N, while client devices 630A-N have provider interfaces 635A-N.

The network 610, to which the client devices 620A-N, 630A-N are coupled, may be a telephonic network, an open network, such as the Internet, or a private network, such as an intranet and/or the extranet. The network 610 may be any collection of distinct networks operating wholly or partially in conjunction to provide connectivity to the client devices, host server, and may appear as one or more networks to the serviced systems and devices. In one embodiment, communications to and from the client devices 620A-N, 630A-N may be achieved by an open network, such as the Internet, or a private network, such as an intranet and/or the extranet. In one embodiment, communications may be achieved by a secure communications protocol, such as secure sockets layer (SSL), or transport layer security (TLS).

The client devices 620A-N, 630A-N can be coupled to the network (e.g., Internet) via a dial-up connection, a digital subscriber loop (DSL, ADSL), cable modem, and/or other types of connection. Thus, the client devices 620A-N, 630A-N can communicate with remote servers (e.g., web server, host server, mail server, instant messaging server) that provide access to user interfaces of the World Wide Web via a web browser, for example.

The reservations database 642 and backup storage 644 may store information such as software, descriptive data, images, system information, drivers, and/or any other data item utilized by parts of the reservation system server 640 for operation. The reservations database 642 and backup storage 644 may be managed by a database management system (DBMS), for example but not limited to, Oracle, DB2, Microsoft Access, Microsoft SQL Server, PostgreSQL, MySQL, FileMaker, etc.

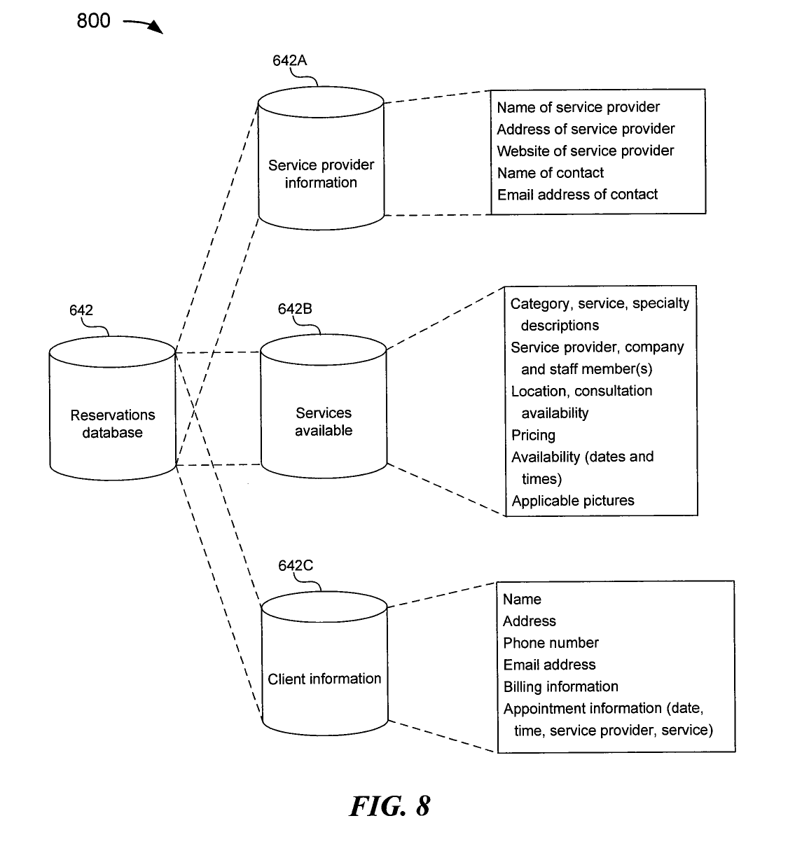

The reservations database 642 and backup storage 644 can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (ORDBMS) (e.g., Informix, OpenLink Virtuoso, VMDS, etc.), a file system, and/or any other convenient or known database management package. An example set of data to be stored in the reservations database 642 and backup storage 644 is further illustrated in FIG. 8.

The reservation system server 640 may be any combination of software agents and/or hardware modules for booking appointments for users and providing client information to service providers. The reservation system server 640 may further include any combination of software agents and/or hardware modules for accepting Hypertext Transfer Protocol (HTTP) requests from end users, external systems, and/or external client devices and responding to the request by providing the requestors with web pages, such as HTML documents and objects that can include static and/or dynamic content (e.g., via one or more supported interfaces, such as the Common Gateway Interface (CGI), Simple CGI (SCGI), PHP, JavaServer Pages (JSP), Active Server Pages (ASP), ASP.NET, etc.).

The reservation system server 640 may also provide an application programming interface (API) that supports requests to the online reservation system made by external computer programs. The API may be used by developers to build their own interface to the reservation system server 640 to access the reservations database 642. Developers must request a key to access the API.

In one embodiment, the API consists of callable Representational State Transfer (REST)-style Uniform Resource Identifiers (URI) that accept or return Extensible Markup Language (XML). Four types of HTTP requests are available: 1) GET which returns data from the remote server, 2) POST which sends data with the intent to create something new, 3) PUT which sends data with the intent to update something that already exists, and 4) DELETE which asks the remote server to remove something. Two types of URIs are available: the collection URI which represents all the resources of a particular type, and the member URI which represents a specific resource from the collection. Requests are authenticated before being accepted by the reservation system server 640.

In addition, a secure connection, SSL and/or TLS can be established by the reservation system server 640. In some embodiments, the reservation system server 640 renders the web pages with graphic user interfaces. The web pages provided by the reservation system server 640 to client users/end devices enable user interface screens 625A-N, 635A-N, for example, to be displayed on client devices 620A-N, 630A-N. In some embodiments, the reservation system server 640 also performs authentication processes before responding to requests for resource access and data retrieval.

In addition, the reservation system server 640 is able to store and retrieve appointments, client information, and service provider data from the reservations database 642 and/or the backup storage 644. In some embodiments, the reservation system server 640 is able to send confirmations by email or text message and accommodate modifications or cancellations of appointments.

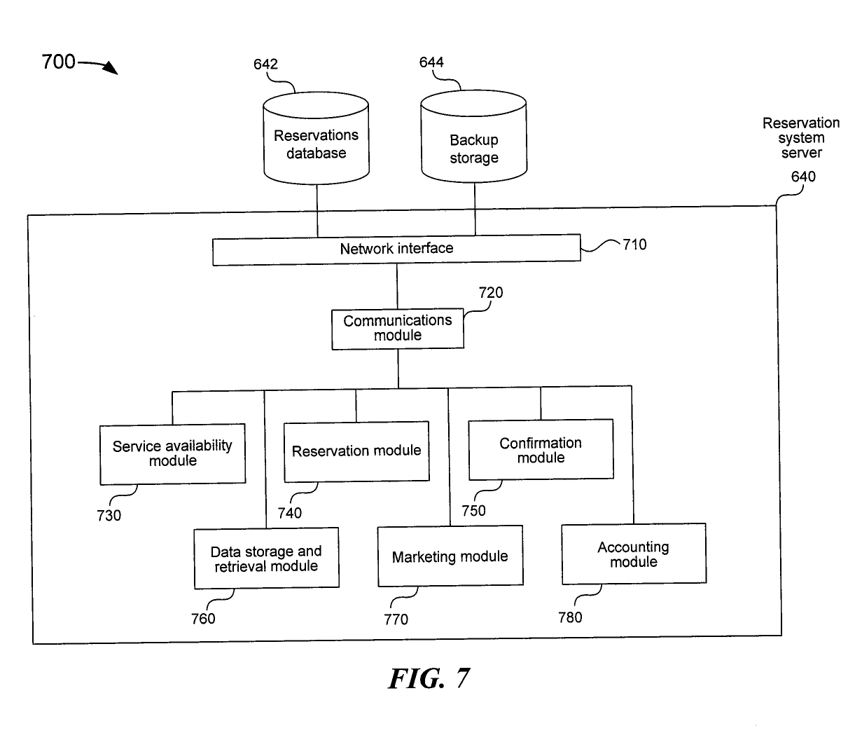

FIG. 7 depicts a block diagram 700 illustrating a system for on online reservation system for multiple categories of service providers, the system to include a reservation system server 640 coupled to a reservations database 642 and a backup storage 644, according to one embodiment.

In the example of FIG. 7, the reservation system server 640 includes a network interface 710, a firewall (not shown), a communications module 720, a service availability module 730, a reservation module 740, a confirmation module 750, and a data storage and retrieval module 760, a marketing module, and an accounting module. Additional or fewer modules may be included. The reservation system server 640 may be communicatively coupled to the reservations database 642, and the backup storage 644, as illustrated in FIG. 2. In some embodiments, the reservations database 642, and the backup storage 644 are partially or wholly internal to the reservation system server 640.

In the example of FIG. 7, the network interface 710 may be one or more networking devices that enable the reservation system server 640 to mediate data in a network with an entity that is external to the host server, through any known and/or convenient communications protocol supported by the host and the external entity. The network interface 710 may include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

A firewall, can, in some embodiments, be included to govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure. In some embodiments, the functionalities of the network interface 710 and the firewall are partially or wholly combined and the functions of which can be implemented in any combination of software and/or hardware, in part or in whole.

In the example of FIG. 7, the reservation system server 640 includes the communications module 720 or a combination of communications modules communicatively coupled to the network interface 710 to manage a one-way, two-way, and/or multi-way communication sessions over a plurality of communications protocols. In one embodiment, the communications module 720 receives data, information, commands, requests, and/or text-based messages over a network. In one embodiment, the communications module 720 receives communications from a network (e.g., Internet, wired and/or wireless network) initiated via a web-interface.

Since the reservation system server 640 is typically compatible with receiving and/or interpreting data originating from various communication protocols, the communications module 720 is able to establish parallel and/or serial communication sessions with users of remote client devices for data and command exchange (e.g., user information and/or user content).

In addition, the communications module 720 may manage log-on requests received from one or more users and/or service providers connecting to the reservation system server 640 including, but not limited to, searching for a service provider; booking, modifying, and canceling appointments; requesting an overview of booked appointments; requesting client data; and changing client or service provider data.

In some instances, authenticated sessions are managed by the communications module 720 for user logon processes. For example, the system may utilize a username/email and password identification method for authorizing access. The communications module 720 may gather data to determine if a user is authorized to access the system and if so, securely logs the user into the system. In other embodiments, other forms of identity authentication, such as security cards and digital certificates may be utilized. A user may be able to specify and/or obtain a logon ID after subscribing or registering.

One embodiment of the reservation system server 640 includes a service availability module 730. The service availability module 730 may be any combination of software agents and/or hardware components able to request and receive detailed information from a service provider about the service provider and available services and resources, including descriptions, pricing, and available appointment times. In one embodiment, the service availability module 730 may provide service provider information to a marketing module 770.

One embodiment of the reservation system server 640 includes a reservation module 740. The reservation module 740 may be any combination of software agents and/or hardware components able to request and receive service provider and appointment preferences from a client including, but not limited to, the name or type of service provider, date and time of appointment, location, and other search criteria; search for service providers meeting the specified criteria; and book appointments for the client.

One embodiment of the reservation system server 640 includes a confirmation module 750. The confirmation module 750 may be any combination of software agents and/or hardware components able to send email, fax, and/or text messages to confirm appointments and to remind clients and service providers of upcoming appointments. If a client or the service provider cancels an appointment for any reason, email, fax, and/or text messages may also be sent by the confirmation module 750.

One embodiment of the reservation system server 640 includes a data storage and retrieval module 760. The data storage and retrieval module 760 may be any combination of software agents and/or hardware components able to store and retrieve information associated with a service provider, service provider staff member, and clients. In addition, a service provider may logon to the online reservation system and request information from the data storage and retrieval module 760 including, but not limited to, daily or weekly appointments, billing information, and client data. A service provider may also enter bookings into the system made, where the bookings for clients were made directly with the service provider over the phone or in person.

One embodiment of the reservation system server 640 includes a marketing module 770. The marketing module 770 may be any combination of software agents and/or hardware components able to providing marketing of services for registered service providers. The marketing module 770 obtains information about services that a service provider offers, and provides marketing services including, but not limited to, internet advertisement on web pages of the online reservation system or other sites, inclusion in online directory services, and mailers.

One embodiment of the reservation system server 640 includes an accounting module 780. The accounting module 780 may be any combination of software agents and/or hardware components able to providing accounting services including, but not limited to, billing clients, sending monthly summary statements to service providers, transferring client payments to the service provider's bank account, and billing service providers monthly for services provided by the online reservation system.

FIG. 8 depicts a block diagram 800 illustrating an example of a reservations database 642 that stores service provider information 642A, services available 642B, and client information 642C, according to one embodiment.

In the example of FIG. 8, the service provider information database 642A can store general information about a service provider including, but not limited to, the name, address, and website of the service provider, and one or more names and emails addresses of representatives of the service provider.

The reservations database 642 may also store detailed information about the services available, for example, in database 642B. The detailed information includes, but is not limited to, the category of service and specialties provided, the name of the service provider and/or staff members providing services, the location of the service provider and whether the service provider will travel to a client's site or provide telephone consultations, pricing, availability of services including dates and times, and any applicable pictures relating to the services provided.

The reservations database 642 may also store client information, for example, in database 642C. Client information includes, but is not limited name, address, phone number, email address, billing information, and appointment information, such as date, time, service provider, and services booked.

The backup storage 644 provides another copy of all information stored in the reservations database 642 used by the online reservations system. The data in the reservations database 642 is saved to the backup storage 644 frequently to prevent loss of data.

The above detailed description of examples of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having functions, or employ systems having blocks, in a different order, and some processes or blocks may be deleted, moved, added, subdivided, combined, and/or modified to provide alternatives or sub-combinations. Each of these processes or blocks may be implemented in a variety of different ways. Also, while processes or blocks are at times shown as being performed in series, these processes or blocks may instead be performed in parallel, or may be performed at different times.

Various features are described which may be exhibited by some embodiments and not by others. Similarly, various requirements are described which may be requirements for some embodiments but not other embodiments.

The use of examples anywhere in this specification including examples of any terms discussed herein is illustrative only, and in no way limits the scope and meaning of the disclosure or of any exemplified term. Likewise, the disclosure is not limited to various embodiments given in this specification.

Although examples have been described with reference to specific exemplary embodiments, it will be evident that the various modification and changes can be made to these examples. Accordingly, the specification and drawings are to be regarded in an illustrative sense rather than in a restrictive sense. The foregoing specification provides a description with reference to specific exemplary embodiments. It will be evident that various modifications may be made. The specification and drawings are, accordingly, to be regarded in an illustrative sense rather than a restrictive sense.

What is claimed is:

1. A method of providing access to an online reservation system offering services selected from multiple categories of service providers, the method comprising:
a. accepting user input for service provider parameters at a website, wherein the parameters comprise a category of service, and further wherein service providers are selected from a group consisting of micro-sized businesses, small-sized businesses, medium-sized businesses, large-sized businesses, government entities, non-profit entities, associations, and clubs;
b. searching for service providers meeting the parameters;
c. accessing data for service providers meeting the parameters, wherein the data comprise availability and pricing for services;
d. displaying the data;
e. accepting a user's selected service provider and appointment time; and
f. booking an appointment with the selected service provider.

2. The method as claimed in claim 1, further comprising allowing the user to pay the selected service provider online.

3. The method as claimed in claim 1, further comprising allowing the user to cancel the appointment online.

4. The method as claimed in claim 1, further comprising sending a confirmation of the appointment to the user and the selected service provider by email, fax, or text message.

5. The method as claimed in claim 1, further comprising sending a reminder about the appointment to the user and the selected service provider by email, fax, or text message.

6. The method as claimed in claim 1, wherein displaying the data comprises displaying a calendar interface indicating availability of a service provider.

7. A method of providing access to an online reservation system offering services selected from multiple categories of service providers, the method comprising:
a. providing a clickable button embedded in a directory services search result for a service provider, wherein the button transfers a user to a reservation website, and further wherein the service provider is selected from a group consisting of micro-sized businesses, small-sized businesses, medium-sized businesses, large-sized businesses, government entities, non-profit entities, associations, and clubs;
b. accessing data for the service provider, wherein the data comprise availability and pricing for services;
c. displaying the data;
d. accepting a user's selected service provider and appointment time; and
e. booking an appointment for the user with the selected service provider.

8. The method as claimed in claim 7, further comprising allowing the user to pay the service provider online.

9. The method as claimed in claim 7, further comprising allowing the user to cancel the appointment online.

10. The method as claimed in claim 7, further comprising sending a confirmation of the appointment to the user and the selected service provider by email, fax, or text message.

11. The method as claimed in claim 1, further comprising sending a reminder about the appointment to the user and the selected service provider by email, fax, or text message.

12. The method as claimed in claim 7, wherein displaying the data comprises displaying a calendar interface indicating availability of the service provider.

13. A method of providing access to an online reservation system offering services selected from multiple categories of service providers, the method comprising:
a. providing a clickable button on a website of a service provider, wherein the button transfers a user to a reservation website, and further wherein the service provider is selected from a group consisting of micro-sized businesses, small-sized businesses, medium-sized businesses, large-sized businesses, government entities, non-profit entities, associations, and clubs;
b. accessing data for the service provider, wherein the data comprise availability and pricing for services;
c. displaying the data;
d. accepting a user's selected service provider and appointment time; and
e. booking an appointment for the user with the selected service provider.

14. The method as claimed in claim 13, further comprising allowing the user to pay the service provider online.

15. The method as claimed in claim 13, further comprising allowing the user to cancel the appointment online.

16. The method as claimed in claim 13, further comprising sending a confirmation of the appointment to the user and the selected service provider by email, fax, or text message.

17. The method as claimed in claim 13, further comprising sending a reminder about the appointment to the user and the selected service provider by email, fax, or text message.

18. The method as claimed in claim 13, wherein displaying data comprises displaying a calendar interface indicating availability of the service provider.
